(19) United States
(12) Patent Application Publication
(10) Pub. No.: US 2009/0233940 A1
(43) Pub. Date: Sep. 17, 2009

(54) Insecticide Compositions

(76) Inventor: George Taylor, Deland, FL (US)

Correspondence Address: Timothy H. Van Dyke;Beusse Wolter Sanks Mora & Maire, P.A., Suite 2500, 390 North Orange Avenue, Orlando, FL, 32801, US

(21) Appl. No.: 12/049,640

(22) Filed: Mar. 17, 2008

(51) Int. Cl. A01N 25/00; A01N 43/60; A01P 3/00; A01P 7/04

(52) U.S. Cl. 514/252.12; 514/772

(57) ABSTRACT

An insecticide composition is provided for killing insects comprising a metal sequestering agent and an insecticide. The composition is particularly useful for killing scale insects, particularly Cycad Asian Scale insects that are hosted by plants of the cycad phyta division. Since the scale insect's shell includes calcium, the metal sequestering agent, when combined with an insecticide and/or fungicide, substantially increases the likelihood that the insecticide and/or fungicide will come into contact with the insect and kill the insect.

### FIELD OF THE INVENTION

The present invention relates to insecticide compositions, and more particularly to insecticide compositions comprising a metal sequestering agent and an insecticide.

### BACKGROUND OF THE INVENTION

The Sago Cycad plant is a common landscaping plant from the Cycas species of plants family native to Asia. Though often referred to as a King or Queen Sago Palm, or just a Sago Palm, the plant is not a palm tree, but a type of gymnosperm. Presently, these common landscaping plants, as well as other Cycas plants, are being destroyed in vast numbers in the United States and throughout the world by insects known as scale insects, and particularly the Cycad Asian Scale (CAS) insect. Typically, the scale insects rest idly on the leaves of the plant and suck plant juices from all parts of the cycad plant, including the roots, thereby devastating the plant. This continuous feeding produces stippled, yellow foliage and stunted plants. Moreover, scale insects reproduce so rapidly that an infected 15-foot queen sago with a spread of over 20 feet may be totally covered in a matter of a few months. Such heavily infested plants die. Scale insects vary in size and diameter, but many varieties, including the Cycad Asian Scale, have a hard, protective shell hidden under a waxy shell-like covering. Known treatments for attempting to control the spread of the Cycad Asian Scale include ultra fine sprays with horticultural oils, insecticidal soaps, sprays with an insecticide, or a drench with a product containing either acephate or imidaclorpid. Due to the protective shell of the scale insect and the rapidity to which they reproduce, known treatments of controlling the growth of scale insects, and in particular the Cycad Asian Scale, have found limited success.

### DETAILED DESCRIPTION OF THE INVENTION

The inventor has unexpectedly found that a composition for killing insects comprising a metal sequestering agent and an insecticide component shows marked improvement in the efficacy of killing scale insects as compared to insecticide alone. Thus, in accordance with one aspect of the invention, a composition is provided for killing insects, and particularly Cycad Asian Scale insects, comprising a metal sequestering agent and an insecticide. While not wishing to be bound by theory, it is believed the metal sequestering agent has an affinity for the insect's shell, which includes calcium, and thus increases the likelihood the insecticide component comes into contact with the insect to kill the insect when a composition comprising the metal sequestering agent and insecticide composition is administered to a medium having the insects.

In accordance with another aspect of the invention, there is provided a composition for killing insects comprising a metal sequestering agent, an insecticide component, and a fungicide component. Since the scale insects may create wounds in a plant that then render the plant susceptible to various fungi, in one embodiment, a fungicide is further added to the composition to guard against fungal growth.

The metal sequestering agent may be any suitable compound or solution having a compound that has an affinity for metal ions, such as alkali earth metal ions, i.e. calcium. Since the scale insect's shell or carapace includes calcium, i.e. calcium phosphate and/or calcium carbonate, it is believed the metal sequestering agent, when combined with an insecticide and/or fungicide as set forth herein, substantially increases the likelihood that the insecticide and/or fungicide will come into contact with the insect. In particular, while not wishing to be bound by theory, once the composition comprising the sequestering agent and at least an insecticide is contacted with the scale insect, the metal sequestering agent is believed to sequester the metal or metal-containing compound of the shell of the insect, bind to the metal or metal-containing compound of the shell of the insect, cover the shell of the insect, and/or penetrate the shell of the insect. The insecticide component and fungicide, if present, may then more easily act upon the insect to kill the insect. In this way, the metal sequestering agent may act as a carrier of the insecticide and fungicide (if present) and overcome the defensive shell of the insect.

As mentioned, the metal sequestering agent may be any suitable compound or solution having a compound that has an affinity for metal ions, and preferably alkali metal ions. In one embodiment, the metal sequestering agent is a solution containing one or more phosphate compounds or polyphosphates selected from the group consisting of orthophosphates, zinc orthophosphates, zinc polyphosphates, ortho polyphosphate blends, linear chain polyphosphates, silicate phosphates, any other phosphate or polyphosphate compound, and combinations thereof, that may sequester or bind to a component of the insect's shell or coat and/or penetrate the alkali metal-based shell of the scale insect. In a particular embodiment, the sequestering agent comprises polyphosphates. One particular source of a suitable solution containing polyphosphates is a product sold under the name AQUA MAG® Polyphosphates from The Carus Corp., Peru, Ill. Other known calcium sequestering agents that may be used in accordance with the present invention include ethylenediaminetetraacetic acid (EDTA), aminoacetic acids and their alkali metal salts, such as nitrilotriacetic acid and alkylenediamine-tetraacetic acid, for example.

To kill the insect once the metal sequestering agent has aided in bringing the insecticide into contact with the insect, the insecticide may be any insecticide or combination of insecticides described herein, or any other known insecticide, suitable to reduce a population of insects, i.e. the Cycad Asian Scale insect. In one embodiment, suitable insecticides include, but are not limited to, organophosphates. The term organophosphates is a generic term referring to insecticides containing phosphorus and may also be referred to as organic phosphates, phosphorus insecticides, nerve gas relatives, phosphates, phosphate insecticides, and phosphorus esters or phosphoric acid esters. Organophosphates are all derived from phosphoric acid and are generally the most toxic of all pesticides to vertebrate animals. Typically, they exert their toxic action by inhibiting the cholinesterase enzymes of the nervous system, which results in the accumulation of acetylcholine. This interferes with neuromuscular junctions producing rapid twitching of the voluntary muscles and eventually paralysis. Generally, there are three types of organophosphates: aliphatic, phenyl, and heterocyclic derivatives.

Aliphatic derivatives are simple phosphoric acid derivatives bearing short carbon chains. Exemplary aliphatic derivatives include malathion, trichlorfon, monocrotophos, dimethoate, dicrotophos, oxydemetonmethyl, disulfoton, dichlorvos, mevinphos, methamidophos, and acephate. Phenyl derivatives contain a benzene ring with one of the ring hydrogens displaced by attachment to phosphorus while other ring hydrogens are typically displaced by other functional groups. These are generally more stable than the aliphatic organophosphates. As a result, their residues are relatively long lasting. Exemplary phenyl derivatives include parathion, stirofos, profenophos, sulprofos, and isofenphos. Heterocyclic derivatives contain ring structures that are composed of different or unlike atoms. One or more of the carbon atoms is displaced by oxygen, nitrogen, or sulfur and their rings may have three, five, or six atoms. Exemplary heterocyclic organophosphates include diazinon, azinphosmethyl, chlorpyrifos, methidathion, phosmet, and dialifor. In one particular embodiment, the insecticide is malathion, an organophosphate parasympathomimetic, which binds irreversibly to cholinesterase. Malathion has been shown to be particularly useful in exterminating Cycad Asian Scale populations.

In another embodiment, the insecticide may be a component that is commercially available and generally considered safe. For example, in one embodiment, the insecticide may be an oil material. Typically, the oil material is designed to kill insects, such as the scale insects, by smothering the invading organisms and depriving them of the oxygen needed for survival. Exemplary material oils include garlic oil, castor oil, cedar oil, cinnamon oil, citronella oil, corn oil, cottonseed oil, geranium oil, lemongrass oil, oinseed oil, malic acid, mint oil, peppermint oil, rosemary oil, sesame oil, thyme oil, and soybean oil. In yet another embodiment, the insecticide may be one of Volk oil, Neem oil, or horticulture oil. Volk oil may be particularly useful during the winter months. One suitable source for Volk oil is Ortho Volk Oil Spray sold by The Scotts Company. Typically, when applied to branches and stems particularly of leafless trees, the oil smothers the insect or insect eggs on the plant and deprives them of oxygen. In a particular embodiment, the insecticide component is malathion and the malathion is mixed with Volk oil, Neem oil, or horticulture oil in a ratio of about 1-4 ounces malathion per gallon of the oil to provide a highly effective composition against the Cycad Asian Scale insect. In a further embodiment, the insecticide may be a fish oil/lecithin combination. One such suitable composition is a fish oil and lecithin combination sold under the name Organocide® that contains 92% fish oil and 3% lecithin. Alternatively, the insecticide may be any suitable animal, vegetable, mineral oil, or other oil safe for application to plants.

In another embodiment, the insecticide may be a desiccant. Desiccants may kill the insect by drying out the insect's internal organs. Suitable desiccants include boric acid, borate-containing compounds, silica gel, calcium sulfate, calcium chloride, montmorillonite clay, molecular sieves or any other known desiccating compound.

In still another embodiment, the insecticide may be a compound or a mixture designed to act as an irritant to the scale insect. For example, such compounds may include vinegar, a vinegar and oil mixture, isopropyl alcohol, or a scented compound, for example. Vinegar, isopropyl alcohol, and scented compounds may act as irritants to the soft outer cuticle of the insects such as the Cycad Asian Scale. Any suitable commercially available vinegar product may be utilized. Exemplary scented compounds may include scented soaps, Tabasco sauce, or any other scented compound or mixture.

Alternatively, the insecticide may be any known insecticide such as carbamates, sodium channel modulators/voltage dependent sodium channel blockers, pyrethroids such as DDT, oxadiazines such as indoxacarb, acetylcholine-receptor agonists/antagonists, acetylcholine-receptor-modulators, nicotine, bensultap, cartap, chloronicotyinyls such as acetamiprid, clothianidin, dinotefuran, imidac loprid, nitenpyram, nithiazine, thiacloprid, and thiamethoxam, spinosyns such as spinosad, cyclodiene organochlorines such as camphechlor, chlordane, endosulfan, gamma-HCH, HCH, heptachlor, lindane, methoxychlor, fiproles such as acetoprole, ethiprole, fipronil, vaniliprole, chloride-channel, 6.1 mectins such as avermectin, emamectin, emamectin-benzoate, ivermectin, and milbemycin, juvenile-hormone mimics such as diofenolan, epofenonane, fenoxycarb, hydroprene, kinoprene, methoprene, pyriproxyfen, and triprene, ecdysone agonists/disruptors, diacylhydrazine, chromafenozide, halofenozide, methoxyfenozide, tebufenozide, chitin biosynthesis inhibitors, benzoylureas such as bistrifluron, chlorfluazuron, diflubenzuron, fluazuron, flucycloxuron, flufenoxuron, hexaflumuron, lufenuron, novaluron, noviflumuron, penfluron, teflubenzuron, triflumuron, buprofezin, cyromazine, oxidative phosphorylation inhibitors, ATP disruptors, diafenthiuron, organotins such as azocyclotin, cyhexatin, fenbutatin-oxide, pyrroles such as chlorfenapyr, dinitrophenols such as binapacryl, dinobuton, dinocap, DNOC, site-I electron transport inhibitors, METI's such as fenazaquin, fenpyroximate, pyrimidifen, pyridaben, tebufenpyrad, tolfenpyrad, hydramethyinon, dicofol, rotenone, acequinocyl, fluacrypyrim, spirodiclofen, spiromesifen, tetramic acids, carboxamides such as flonicamid, octopaminergic agonists such as amitraz, magnesium-stimulated ATPase inhibitors such as propargite, BDCA's such as N2-[1,1-dimethyl-2-(methylsulfonyl)ethyl]-3-iodo-N1-[2-methyl-4-[1,2,2,2-tetrafluoro-1-(trifluoromethyl)ethyl]phenyl]-1,2-benzene, nereistoxin analogues such as thiocyclam hydrogen oxalate, and thiosultap sodium, biological agents, hormones or pheromones such as azadirachtin, bacillus spp., Beauveria spp., codlemone, metarrhizium spp., Paecilomyces spp., Thuringiensin, Verticillium spp., fumigants such as aluminium phosphide, methyl bromide, and sulfuryl fluoride, selective antifeedants such as cryolite, flonicamid, and pymetrozine, and mite growth inhibitors such as clofentezine, etoxazole, and hexythiazox.

In yet another embodiment, the insecticide further includes a component that enhances the effectiveness of the insecticide. For example, the insecticide composition may further include an oil, a desiccant (to aid in depositing the component on the plant), vinegar, a vinegar and oil mixture, isopropyl alcohol, or a scented compound, for example. As mentioned above, vinegar and scented compounds may act as irritants to the soft outer cuticle of insects such as the Cycad Asian Scale. Any suitable commercially available vinegar product may be utilized. Exemplary scented compounds may include scented soaps, Tabasco sauce, or any other scented naturally safe compound. In this embodiment, the insecticide composition typically includes an insecticide other than an oil, desiccant, or irritant, such as an organophosphate, and the oil, desiccant, or irritant is added to aid in the effectiveness of the composition. Note, however, the oil, desiccant, or irritant may still have insecticidal properties as described above.

In addition, because of the Cycad Asian Scale's waxy coating, it is contemplated that providing the insecticide composition with an oil material and thereafter providing the insecticide composition in the form of a mixture, solution, suspension, or emulsion may aid in maintaining the composition in contact with the plant when the insecticide composition is applied to a plant. Thus, in accordance with another aspect of the invention, the insecticide composition may comprise a metal sequestering agent, an oil material, and an insecticide. In such an embodiment, the insecticide of the composition is typically an insecticide other than an oil. The oil material may comprise any oil mentioned herein.

As discussed above, since the scale insects feed on plants, a plant infested with scale insects may quickly develop open wounds from Cycad Asian Scale infestation, which render the plant highly susceptible to fungal attack. To protect against this problem, optionally, any of the compositions described herein may further include a fungicide for preventing fungal growth on the plant. Any suitable fungicide known in the art may be utilized. Suitable fungicides include, for example, aldimorph, ampropylfos, ampropylfos-potassium, andoprim, anilazin, azaconazol, azoxystrobin, benalaxyl, benodanil, benomyl, benzamacril, benzamacril-isobutyl, bialaphos, binapacryl, biphenyl, bitertanol, blasticidin-S, bromuconazole, bupirimate, buthiobate, calcium polysulfide, capsimycin, captafol, captan, carbendazim, carboxin, carvone, chinomethionat, chlobenthiazone, chlorfenazole, chloroneb, chloropicrin, chlorothalonil, chlozolinate, clozylacon, cufraneb, cymoxanil, cyproconazole, cyprodinil, cyprofuram, debacarb, dichlorophen, diclobutrazol, dichlofluanid, diclomezine, dicloran, diethofencarb, difenoconazole, dimethirimol, dimethomorph, diniconazole, diniconazole-M, dinocap, diphenylamine, dipyrithione, ditalimfos, dithianon, dodemorph, dodine, drazoxolon, edifenphos, epoxiconazole, etaconazole, ethirimol, etridiazole, famoxadone, fenapanil, fenarimol, fenbuconazole, fenfuram, fenitropan, fenpiclonil, fenpropidin, fenpropimorph, fentin acetate, fentin hydroxide, ferbam, ferimzone, fluazinam, flumetover, fluoroimide, fluquinconazole, flurprimidol, flusilazole, flusulfamide, flutolanil, flutriafol, folpet, fosetyl-aluminium, fosetyl-sodium, fthalide, fuberidazole, furalaxyl, furametpyr, furcarbonil, furconazole, furconazole-cis, furmecyclox, guazatine, hexachlorobenzene, hexaconazole, hymexazol, imazalil, imibenconazole, iminoctadine, iminoctadine albesilate, iminoctadine triacetate, iodocarb, ipconazole, iprobenfos (IBP), iprodione, irumamycin, isoprothiolane, isovaledione, kasugamycin, kresoxim-methyl; copper preparations, such as copper hydroxide, copper naphthenate, copper oxychloride, copper sulfate, copper oxide, oxine copper and Bordeaux mixture, mancopper, mancozeb, maneb, ferimzone, mepanipyrirri, mepronil, metalaxyl, metconazole, methasulfocarb, methfuroxam, metiram, metomeclan, metsulfovax, mildiomycin, myclobutanil, myclozolin, nickel-dimethyidithiocarbamate, nitrothal-isopropyl, nuarimol, ofurace, oxadixyl, oxamocarb, oxolinic acid, oxycarboxin, oxythiinh, paclobutrazol, pefurazoate, penconazole, pencycuron, phosdiphen, pimaricin, piperalin, polyoxin, polyoxorim, probenazole, prochloraz, procymidone, propamocarb, Propanosine-sodium, propiconazole, propineb, pyrazophos, pyrifenox, pyrimethanil, pyroquilon, pyroxyfur, quinconazole, quintozene (PCNB), sulfur and sulfur preparations, tebuconazole, tecloftalam, tecnazene, tetcyclacis, tetraconazole, thiabendazole, thicyofen, thifluzamide, thiophanate-methyl, thiram, tioxymid, tolclofos-methyl, tolylfluanid, triadimefon, triadimenol, triazbutil, triazoxide, trichiamide, tricyclazol, tridemorph, triflumizole, triforin, triticonazole, uniconazole, validamycin A, vinclozolin, diniconazol, zarilamid, zineb, and ziram.

Further, other fungicides for use in the invention may include, but are not limited to, dagger G, OK-8705, OK-8801, alpha(1,1-dimethylethyl)-β-(2-phenoxyethyl)-1H-1,2,4-triazole-1-ethanol, alpha(2,4-dichlorophenyl)-β-fluor-b-propyl-1H-1,2,4-triazole-1-ethanol, alpha(2,4-dichlorophenyl)-β-methoxy-a-methyl-1H-1,2,4-triazole-1-ethanol, (5RS,6RS)-6-hydroxy-2,2,7,7-tetramethyl-5-(1H-1,2,4-triazole-1-yl)-3-octanone, (E)-a-(methoxyimino)-N-methyl-2-phenoxyphenylacetamide, isopropyl 1-{2-methyl-1-[[[1-(4-methylphenyl)-ethyl]-amino]-carbonyl]-propyl}-carbamate, 1-(2,4-dichlorophenyl)-2-(1H-1,2,4-triazole-1-yl)-ethanone-O-(phenylmethyl)-oxime, 1-(2-methyl-1-naphthalenyl)-1H-pyrrol-2,5-dione, 1-(3,5-dichlorophenyl)-3-(2-propenyl)-2,5-pyrrolidindione, 1-[(diiodomethyl)-sulfonyl]-4-methyl-benzene, 1-[[2-(2,4-dichlorophenyl)-1,3-dioxolane-2-yl]-methyl]-1H-imidazole, 1-[[2-(4-chlorophenyl)-3-phenyloxiranyl]-methyl]-1H-1,2,4-triazole, 1-[1-[2-[(2,4-dichlorophenyl)-methoxy]-phenyl]-ethenyl]-1H-imidazole, 1-methyl-5-nonyl-2-(phenylmethyl)-3-pyrrolidinole, 2′,6′-dibromo-2-methyl-4′-trifluoromethoxy-4′-trifluoro-methyl-1,3-thiazole-5-carboxanilide, 2,2-dichloro-N-[1-(4-chlorophenyl)-ethyl]-1-ethyl-3-methyl-cyclopropanecarboxamide, 2,6-dichloro-5-(methylthio)-4-pyrimidinyl-thiocyanate, 2,6-dichloro-N-(4-trifluoromethylbenzyl)-benzamide, 2,6-dichloro-N-[[4-(trifluoromethyl)-phenyl]-methyl]-benzamide, 2-(2,3,3-triiodo-2-propenyl)-2H-tetrazole, 2-[(1-methylethyl)-sulfonyl]-5-(trichloromethyl)-1,3,4-thiad iazole, 2-[[6-deoxy-4-O-(4-O-methyl-.beta.-D-glycopyranosyl)-a-D-glucopyranosyl]-amino]-4-methoxy-1H-pyrrolo[2,3-d]pyrimidine-5-carbonitrile, 2-aminobutane, 2-bromo-2-(bromomethyl)-pentanedinitrile, 2-chloro-N-(2,3-dihydro-1,1,3-trimethyl-1H-indene-4-yl)-3-pyridinecarboxamide, 2-chloro-N-(2,6-dimethylphenyl)-N-(isothiocyanatomethyl)-acetamide, 2-phenylphenol (OPP), 3,4-dichloro-1-[4-(difluoromethoxy)-phenyl]-1H-pyrrole-2,5-dione, 3,5-dichloro-N-[cyan[(1-methyl-2-propynyl)-oxy]-methyl]-benzamide, 3-(1,1-dimethylpropyl-1-oxo)-1H-indene-2-carbonitrile, 3-[2-(4-chlorophenyl)-5-ethoxy-3-isoxazolidinyl]-pyridine, 4-chloro-2-cyan-N,N-dimethyl-5-(4-methylphenyl)-1H-imidazole-1-sulfonamide, 4-methyl-tetrazolo[1,5-a]quinazolin-5(4H)-one, 8-(1,1-dimethylethyl)-N-ethyl-N-propyl-1,4-dioxaspiro[4.5]decan-2-methanamine, 8-hydroxyquinoline sulfate, 9H-xanthene-2-[(phenylamino)carbonyl]-9-carboxylic hydrazide, bis-(1-methylethyl)-3-methyl-4-[(3-methylbenzoyl)-oxy]-2,5-thiophene dicarboxylate, cis-1-(4-chlorophenyl)-2-(1H-1,2,4-triazole-1-yl)-cycloheptanol, cis-4-[3-[4-(1,1-dimethylpropyl)-phenyl-2-methylpropyl]-2,6-dimethyl-morpholin-hydrochloride, ethyl-[(4-chlorophenyl)-azo]-cyanoacetate, potassium hydrogen carbonate, methane tetrathiol sodium salt, methyl-1-(2,3-dihydro-2,2-dimethyl-1H-indene-1-yl)-1H-imidazole-5-carboxylate, methyl-N-(2,6-dimethylphenyl)-N-(5-isoxazolylcarbonyl)-DL-alaninate, N-(2,3-dichloro-4-hydroxyphenyl)-1-methyl-cyclohexanecarb oxamide, N-(2,6-dimethylphenyl)-2-methoxy-N-(tetrahydro-2-oxo-3-furanyl)-acetamide, N-(2,6-dimethylphenyl)-2-methoxy-N-(tetrahydro-2-oxo-3-thienyl)-acetamide, N-(2-chloro-4-nitrophenyl)-4-methyl-3-nitro-benzenesulphonamide, N-(4-cyclohexylphenyl)-1,4,5,6-tetahydro-2-pyrimidineamine, N-(4-hexylphenyl)-1,4,5,6-tetrahydro-2-pyrimidineamine, N-(5-chloro-2-methylphenyl)-2-methoxy-N-(2-oxo-3-oxazolidinyl)-acetamide, N-(6methoxy)-3-pyridinyl)-cyclopropanecarboxamide, N-[2,2,2-trichloro-1-[(chloroacetyl)amino]-ethyl]-benzamiide, N-[3-chloro-4,5-bis(2-propinyloxy)-phenyl]-N′-methoxy-methanimidamide, N-formyl-N-hydroxy-DL-alanine-sodium salt, O,O-diethyl[2-dipropylamino)-2-oxoethyl]-ethylphosphorami dothioate, O-methyl S-phenyl phenylpropylphosphoraridothioate, S-methyl 1,2,3-benzothiadiazole-7-carbothioate, and spiro[2H]-1-benzopyran-2,1′(3′H)-isobenzofuran]-3′-one.

In one particular embodiment, the fungicide may be a solution that contains triforine, a piperazine-derived fungicide, that is otherwise identifiable as N,N′-[1,4-Piperazinediyl-bis(2,2,2-trichloroethyl-idene)]-bis-[formamide]. A suitable product containing triforine is available under the trade name Funginex® from the BASF Corporation. When applied to the plant, the fungicide may aid in preventing fungal growth on the plant. Moreover, when the composition including the metal sequestering agent sequesters, binds, coats and/or permeates through at least a portion of the shell of the scale insect, the metal sequestering agent may also aid the fungicide, as well as the insecticide, to act on the scale insect.

The insecticide composition may further include additional components such as a carrier selected from agriculturally suitable liquid diluents, solid diluents, and surfactants. Suitable solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Suitable liquid diluents include, for example, water, N,N-dimethylformamide, dimethyl sulfoxide, N-alkylpyrrolidone, ethylene glycol, polypropylene glycol, paraffins, alkylbenzenes, alkylnaphthalenes, oils of olive, castor, linseed, tung, sesame, corn, peanut, cottonseed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol and tetrahydrofurfuryl alcohol. Suitable surfactants for use in the present invention include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, and polyoxyethylene/polyoxypropylene block copolymers.

The ingredients of the composition are selected to be consistent with the physical properties of the active ingredient, mode of application and environmental factors, such as plant type and outdoor temperature. Useful formulations may include liquids such as solutions (including emulsifiable concentrates), mixtures, suspensions, emulsions, and the like. Useful formulations may also include solids such as dusts, powders, granules, pellets, tablets, films, and the like that may be water-dispersible (“wettable”) or water-soluble. The active ingredients of the composition may be (micro) encapsulated and further formed into a suspension or solid formulation. Encapsulation can control or delay release of the active ingredient, i.e. the insecticide compound. Additional components may also be added to reduce foam or increase viscosity as needed. Surfactants, including ionic and nonionic surfactants, and combinations thereof, may be added to the compositions to further increase the likelihood that the compositions will adhere to the plant surface and the shell surface of the insect surface rather than bead off the waxy protective coating of the insect.

The relative amount of the metal sequestering agent to the insecticide and fungicide (if provided) may be determined by considering the amount of the sequestering agent, the insecticide component, and the fungicide component necessary to bring about the desired effect of killing the scale insects. In one embodiment, the ratio of the sequestering agent to the insecticide component may be in the range of from about 1:10 to 10:1, and in another embodiment, from 1:5 to 5:1. When a fungicide is incorporated, in one embodiment, the ratio of the sequestering agent to the fungicide component to the may be in the range of from about 1:10 to about 10:1, and in another embodiment, from about 1:5 to about 5:1.

The compositions of the present invention may be prepared as mixtures, solutions, suspensions, or emulsions. Mixtures and solutions may be prepared by mixing the components of the composition by any suitable method known in the art. Suspensions may be prepared by wet milling or by any other known method in the art. Emulsions may be prepared by mixing the components by any suitable method in the art, and typically include a surfactant as discussed above.

Once prepared, the insecticide compositions are typically applied to the subject plants by spraying the composition on the plants. Alternatively, any other method of applying the composition may be used. Because the Cycad Asian Scale insects reproduce so rapidly, it is desirable to apply the composition to the top and underside of the leaves of the plants, as well as around the trunk and root system of the plant. The insecticide component is preferably applied to infected plants at least 1-2 times per week and treatment may continue for as long as is necessary to eliminate or substantially reduce the scale insect population. Intermittently, between treatments, it may be desirable to rinse the plants with a water rinse to rid the plants of dead organisms.

### EXAMPLE 1

The following example of the application of an insecticide solution is intended for heavily infested Cycad plants that require immediate attention due to a life threatening infestation of the Cycad Asian Scale (CAS). 1 gallon of an insecticide solution is prepared as follows. An approved 1 gallon container was filled approximately half full of potable water. 4-8 ounces of an AQUA MAG® Polyphosphates solution (a blended polyphosphate solution) was added to the water. The blended polyphosphate acts as a chelating agent in the mixture, breaking down the defense of the Cycad Asian Scale by sequestering the protective outer shell of the organism (i.e. which is comprised of alkaline earth metals), thereby carrying the lethal solution to the organism. 5 ounces of the insecticide (i.e. Malathion 50) was added to the water/polyphosphate solution. Next, 5 ounces of the fungicide component (a product containing triforine sold under the name Funginex® from the BASF Corporation, Toronto, Ontario) was added to the solution. Finally, 5 ounces of horticultural oil was added and mixed well. The whole solution was diluted to volume (1 gallon) to produce 1 gallon of insecticide solution. Alternatively, the added oil may be soybean oil, sesame seed oil, or any other suitable oil. These oils are designed to kill further insects by smothering the invading organisms and depriving them of the oxygen needed for survival.

The above-prepared solution was applied to infested King and Queen Sago palms once a week for a period of three (3) weeks. The resulting mixture was mixed periodically during its application to provide a reasonably consistent coating over the entire plant. After the 3-week treatment with the insecticide composition, the management phase was implemented and the plants were treated once monthly for 2 months. Subsequent treatment was performed quarterly or until robust growth was observed, at which time treatment was suspended. The plants showed marked improvement after one application and returned to a normal growth pattern after a 3-month period.

### EXAMPLE 2

For moderately infested Cycad plants that show signs of the Cycad Asian Scale, but do not require immediate attention, a 1 gallon solution of the insecticide composition was prepared and applied to the plants to the same extent as in Example 1 except that ½ the volume of the above additives were used. After application to the infected Cycad plants in the same manner set forth in Example 1, the plants showed marked improvement after one application and returned to a normal growth pattern after a 3-month period.

### EXAMPLE 3

For preventing Asian Cycad Scale infestation, particularly when the Cycad Asian Scale is observed in the subject neighborhood or a surrounding area, a 1 gallon of the solution was prepared with ½ the volume of the additives set forth in Example 1, and without the fungicide. The treated Cycad plants continued a normal growth pattern after a 3-month period with no visible infestation.

### EXAMPLE 4

An environmentally safe insecticide composition usable around a person's home for a variety of pests was prepared as follows. An approved 1 gallon container was filled approximately half full of potable water and 4 ounces of the AQUA MAG® Polyphosphates solution was added to the water and mixed well. 2 ounces of an insecticide sold under the name Organocide®, available from Home Harvest Garden Supply, East Lansing, Mich. (for example) was then added to the water. Organocide® is a nature-safe, organic spray oil that contains edible fish oil (92%) and lecithin (3%). The solution was mixed well and diluted to 1 gallon with water. This solution was applied to the infested King and Queen Sago palms once a week for a period of three (3) weeks. After a 3 week treatment with the solution, a management phase was implemented and the plants were treated once monthly for 2 months. Subsequent treatment was performed quarterly or until robust growth was observed, at which time treatment was suspended. The plants showed marked improvement after one application and returned to a normal growth pattern after a 3-month period.

### EXAMPLE 5

Insect growth regulators (IGR) are effective in controlling the insects' maturation to adulthood. The active ingredient in one particular IGR, Precor 2000 (i.e. Methoprene 0.085%, Permethrin 0.35%, Phenothrin 0.30%), prevents the eggs and larvae stages of the insect from developing to adulthood and has a 3 to 7 month residual. To prepare an exemplary useful Precor 2000 composition, an approved 1 gallon container approximately was filled half full of potable water and ½ cup of AQUA MAG® Polyphosphates solution was added. Thereafter, an amount of Precor 2000 was added to the container according to the manufacturer's recommended instructions along with 2 oz. of tea tree oil (which acts as a fungicide). The ingredients were mixed well and diluted to 1 gallon with water. The insecticide was applied to infected plants as instructed in the previous examples. The plants showed improvement after one application.

### EXAMPLE 6

The Insect Growth Regulator (IGR) Nylar is the active ingredient in Archer IGR, an insecticide available from Sygenta Crop Protection, Inc., Greensboro, N.C., and other insecticides. Nylar includes 1.3 ethoxyl pyridine and is photostable, meaning it can be used outdoors as well as indoors. Nylar also has a 3- to 6-month residual indoors and can last for 30 days when used outdoors. To produce an exemplary useful Nylar composition, an approved 1 gallon container was filled approximately half full of potable water and ½ cup of AQUA MAG® Polyphosphates solution. Thereafter, 4 ounces of concentrated garlic oil and 4 ounces of a fungicide were added. The Archer IGR was then added according to the manufacturer's recommended concentration, the ingredients were mixed well, and diluted to one gallon with water. The ingredients were mixed well and diluted to 1 gallon. The insecticide was applied to infected plants as instructed in the previous examples. The plants showed improvement after one application.

### EXAMPLE 7

### Desiccants

Desiccants provide an effective method for controlling insect infestations by drying out the insect's internal organs, thereby killing it. Boric acid or other borate-containing compounds, for example, are effective desiccating agents that readily dissolve in solution and can be effectively dispensed. One exemplary product containing a borate compound is sold under the commercial name Mop Up® (which contains 98% Disodium Octoborate Tetrahydrate) and is available from Waterbury Companies, Inc., Waterbury, Conn. To provide an exemplary useful borate-containing solution, an approved 1 gallon container was filled approximately half full of potable water and ½ cup of AQUA MAG® Polyphosphates solution, 4 oz of concentrated garlic oil, and 4 oz of a fungicide were added and mixed well. Finally, 4 tablespoons of boric acid crystals were added to the solution, the ingredients were mixed well, and diluted to volume with water. The insecticide was applied to infected plants as instructed in the previous examples. The plants showed improvement after one application.

### EXAMPLE 8

### Isopropyl Alcohol

Rubbing alcohol or isopropyl alcohol is probably one of the most popular home remedies for treating scale insects. Other alcohols, however, such as ethanol or methanol should not be used because these alcohols can penetrate the plant tissues rapidly and cause considerable damage. The concentration of the isopropyl alcohol used seems to make little difference in the treatment of plants infected with the Cycad Asian Scale; the common 70% solution available in hardware and drug stores is satisfactory. The life cycle of the particular species of scale insects infesting the subject plants should be closely monitored.

To prepare a useful isopropyl alcohol solution, an approved 1 gallon container was filled approximately half full of potable water and ½ cup of AQUA MAG® Polyphosphates solution, 4 oz of Neem oil, and 4 oz of a fungicide were added, mixed well, and diluted to 1 gallon with 70% isopropyl alcohol. The insecticide was applied to infected plants as instructed in the previous examples. However, repeated treatment against the immature insects were performed every 1-2 weeks. The plants showed improvement after one application.

### EXAMPLE 9

### Acid

A repellant such as white distilled vinegar is effective and actively irritates the soft outer cuticle of the insect in combination with such penetrating agents as the blended polyphosphates. To prepare an exemplary useful vinegar-containing solution, an approved 1 gallon container was filled approximately half full of potable water and ½ cup of a blended polyphosphate, 4 oz of soybean oil, and 4 oz of white distilled vinegar were added, mixed well, and diluted to 1 gallon with water. The insecticide was applied to infected plants as instructed in the previous examples. The plants showed improvement after one application.

### EXAMPLE 10

### Green Alternative

A “green alternative” to environmentally dangerous insecticide include components that repel insects with such scents as peppermint and Tabasco sauce. To prepare an exemplary environmentally safe composition, an approved 1 gallon container was filled approximately half full of potable water and ½ cup of AQUA MAG® Polyphosphates solution, 8 oz of Dr. Bronner's Liquid Soap—Peppermint, and 6 oz of Tabasco sauce were added, mixed well, and diluted to 1 gallon with water. The insecticide was applied to infected plants as instructed in the previous examples. The plants showed improvement after one application.

These and other advantages will be apparent from the disclosure of the invention(s) contained herein. As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The above-described embodiments and configurations are neither complete nor exhaustive. As will be appreciated, other embodiments of the invention are possible utilizing, alone or in combination, one or more of the features set forth above or described in detail below.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What I claim is:

1. An insecticide composition for killing insects comprising:
a metal sequestering agent; and
an insecticide.

2. The insecticide composition of claim 1, wherein the metal sequestering agent comprises polyphosphates.

3. The insecticide composition of claim 1, wherein the insecticide comprises an organophosphate compound.

4. The insecticide composition of claim 1, wherein the insecticide further comprises one or more of a scented compound, isopropyl alcohol, a desiccant, vinegar, an oil material, and combinations thereof.

5. The insecticide composition of claim 1, wherein the insecticide is not an oil, and further comprising an oil material.

6. The insecticide composition of claim 5, wherein the oil material is one of Volk, horticulture, and Neem oil.

7. The insecticide composition of claim 1, wherein the ratio of the metal sequestering agent to the insecticide is from about 1:10 to about 10:1.

8. The insecticide composition of claim 7, wherein the ratio of the metal sequestering agent to the insecticide is from about 1:5 to about 5:1.

9. The insecticide composition of claim 1, further comprising a fungicide.

10. The insecticide composition of claim 9, wherein the fungicide comprises triforine.

11. The insecticide composition of claim 9, wherein the ratio of the metal sequestering agent to the fungicide is from about 1:10 to about 10:1.

12. The insecticide composition of claim 11, wherein the ratio of the metal sequestering agent to the fungicide is from about 1:5 to about 5:1.

13. A method for treating a plant infected with insects, comprising:
applying a composition comprising a metal sequestering agent and an insecticide to the infected plant.

14. The method of claim 13, wherein the metal sequestering agent comprises polyphosphates.

15. The insecticide composition of claim 13, wherein the insecticide comprises one of a scented compound, isopropyl alcohol, a desiccant, vinegar, an oil material, and combinations thereof.

16. The insecticide composition of claim 13, wherein the ratio of the metal sequestering agent to the insecticide is from about 1:10 to about 10:1.

17. The method of claim 13, further comprising a fungicide.

18. The method of claim 13, wherein the ratio of the metal sequestering agent to the fungicide is from about 1:10 to about 10:1.

19. The method of claim 13, wherein the insecticide composition is applied to the infected plant at least once weekly for a period of three weeks and thereafter, at least one monthly for a period of at least two months.
